(19) United States
(12) Patent Application Publication
(10) Pub. No.: US 2009/0113183 A1
(43) Pub. Date: Apr. 30, 2009

(54) METHOD OF CONTROLLING A DEVICE AND A DEVICE CONTROLLED THEREBY

(75) Inventors: Lee A. BARFORD, San Jose, CA (US); Steven A. NEWTON, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/933,189

(22) Filed: Oct. 31, 2007

(51) Int. Cl. G06F 9/22

(52) U.S. Cl. 712/220; 712/E09.004

(57) ABSTRACT

A method of controlling at least one device is disclosed. The method includes providing the device with at least one constraint for carrying out an operation. The device determines if the constraint can be met. If it is determined that the constraint can be met, the device determines on its own accord a manner to get into a state wherein the constraint will be met. The device then goes into the state in the determined manner. A device that is controlled by the method and a system including such a device are also disclosed.

### BACKGROUND

A measurement, test or control system typically includes a controller connected to a number of devices. The controller may include one or more computers, processors or other suitable control units. The devices may include instruments, signal sources, switches, multiplexers, up-converters, down-converters, sensors, smart sensors, actuators, smart actuators and the like. The controller sends control information or instructions to the devices. The devices in turn send information such as status or measured data to the controller.

When using a device, such as an instrument, it is often necessary for the controller to put the instrument through a series of states into a desired state for making a measurement or generating an output signal. A state is a unique configuration or combination of all the settings of the instrument. These settings include, but are not limited to, relay or other analog signal path selections, attenuator and amplifier settings, analog filters selection and de-selection, digital hardware settings, DSP ASIC settings and software parameter selections. Digital hardware settings include, among others, setting of the sampling rate and number of samples to accumulate. The DSP ASIC settings include setting of the decimation rate and digital upconversion or downconversion frequency. The software parameter selections include, among others, the averaging time setting, windowing function selection, and digital filter selection. The instrument is put into a desired state for example to measure physical variables (e.g. voltage, current, light wave power) within a certain range and latency, at a certain rate, and with a certain accuracy or to generate an output signal at a user specified frequency, amplitude, etc. A typical test sequence or set of measurements involves putting an instrument through a series of such states to end up in a desired state. In particular, in a test system, for each test in a series of tests to be carried out on each device under test (DUT), each instrument must typically be set to a particular new state.

To bring the instrument to a desired state in the prior art, the controller may send a series of Standard Commands for Programmable Instrumentation (SCPI) commands to the instrument to get it to transition through a corresponding series of states to the desired state. The first of the series of commands is typically one that brings the instrument to a “turn-on” or default state. After that, the controller sends the other commands in the series, one after another, to the instrument to cause it to transition through some series of states to the final desired state.

Such a method involving SCPI commands may be a waste of communications bandwidth between the controller and the instrument, instrument processor usage, and time. This is because it takes time for each command has to be transmitted to the instrument. The instrument receives a message containing the command via a protocol stack. Processing of such a protocol stack is also time-consuming. Time and processor resources are also taken to parse, interpret and execute each command. This is especially so when the instrument, which is already in a state that is similar or close to the desired state, has to be brought to the desired state from scratch. All that may be required may be a couple of commands to bring the instrument from a current state to the desired state. But instead, the instrument is redundantly brought back to the default state and from there on to the desired state. The long series of commands might also render effective optimization of physical component switching by the instrument difficult or impossible.

The process of writing and debugging the sequence of commands that causes a state change and the program that sends the commands is time consuming and error prone because instrument states are always implicit (the result of some set of commands) rather than explicitly stated and set. The commands in the series are also often instrument dependent. It is not easy to find an instrument that is 100% compatible with another older instrument. When switching to a new instrument that is not totally compatible, the series of commands might have to be changed.

In the prior art, there are modular instruments that may be integrated into a single system. In such instruments, instrument states are set by writing into registers in the instruments. At each instrument state transition, the complete new instrument state is written into a set of registers that specify the state. Such an implementation is less time consuming compared to the system described above. However, this solution is only available on instruments that provide a register-based programmatic interface. Typically, to support such an interface, the communication means is a local bus such as VXI, PCI, PCI-express, PXI, or USB. Thus, the distance between the controller and any instrument is limited. The contents and meaning of such registers are nonetheless still rather specific to the hardware implementation of the instrument. It is difficult to keep the register contents and meaning consistent across instrument models (even for the same manufacturer) and over time as instrument implementation technologies evolve. Consequently, test programs for register-based instruments generally have to be re-written when an instrument is replaced due to its failure, lack of reliability, or because it can no longer be calibrated.

### BRIEF DESCRIPTION OF DRAWINGS

The invention will be better understood with reference to the drawings, in which:

FIG. 1 is a block diagram of a test system including a controller and two instruments controlled by the controller, according to an embodiment of the invention;

FIG. 2 is a block diagram of each of the controller and the instruments;

FIG. 3 is a drawing showing a sequence of operations in the controller and the instruments in FIG. 1 for the controller to control the instruments according to another embodiment of the invention; and

FIG. 4 is a drawing showing an examplary state space of an instrument in FIG. 1.

### DETAILED DESCRIPTION OF THE EMBODIMENTS

As shown in the drawings for purposes of illustration, the invention may be implemented in a method of controlling at least one device. The method includes providing the device with at least one constraint for carrying out an operation. The device then determines if the constraint can be met by the device. If it is determined that the constraint can be met, the device determines on its own accord a manner to get into a state wherein the constraint will be met. The device will then go into the state according to the determined manner. This determined manner may or may not require the device to return to a default state.

Unlike in the prior art where the instrument has to be guided step by step by a controller into the desired state, all the controller has to do according to the above described method is to let the device know one or more constraints. The device then checks to see if the constraints can be met. If it is determined that the constraints can be met, the device then decides on its own, not externally guided, how best to get from its current state to the desired state. In this manner, communication between the controller and the instrument is reduced. And since the instrument knows its current state and the desired state, it can be programmed to move directly from the current state to the desired state without first having to be put into the default state.

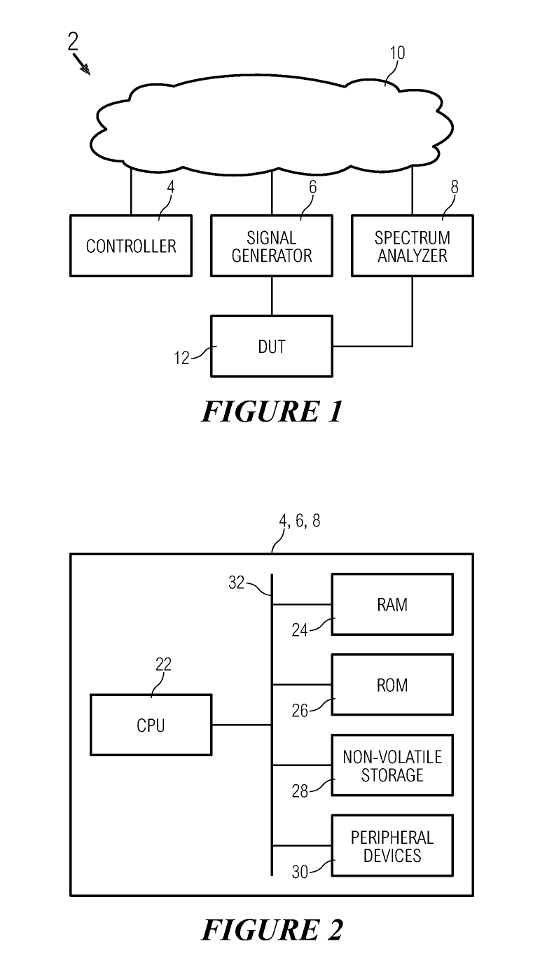

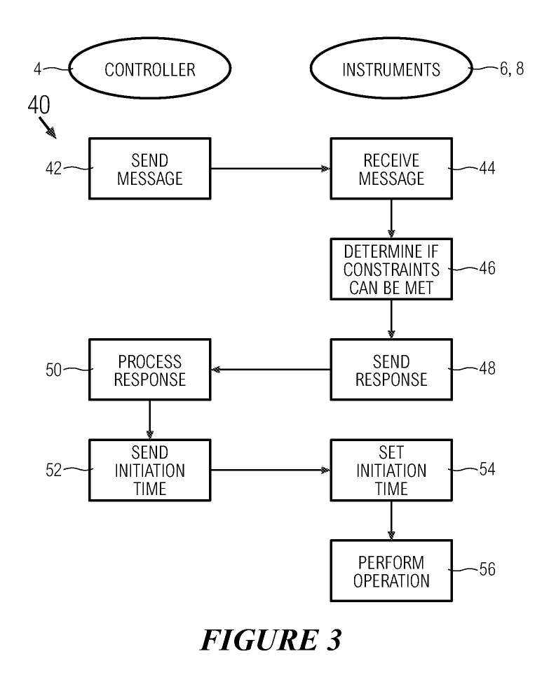

FIG. 1 a block diagram showing a system 2 according to an embodiment of the invention. The system 2 includes a controller 4 and two instruments 6, 8, connected to one another via an Ethernet 10. One instrument is a signal generator 6 and the other instrument is a spectrum analyzer 8. The controller 4 and the two instruments 6, 8 are LXI compliant devices. More specifically, these devices 4, 6, 8 are LXI Class B devices, each of which includes a standardized LAN interface. These devices 4, 6, 8 are thus communicatively coupled and are capable of sending and receiving peer-to-peer messages. The messages can contain a timestamp representing the time of occurrence of some event. Each device 4, 6, 8 includes a IEEE 1588 clock (not shown) and supports the Precision Time Protocol (PTP) defined in the IEEE 1588—2002 standard. Supporting the IEEE 1588 standard enables these devices to have a sense of time and thus allows the precise synchronization of the devices. Accuracy of time within the nanosecond range can be achieved by using hardware generated timestamps in the devices. During use the instruments 6, 8 are connected to a DUT 12 for measuring, for example, the power spectrum of the DUT 12. In one embodiment, the operations in the instruments 6, 8 are carried out at precisely the same time to avoid any discrepancy. A sequence 40 (FIG. 3) of steps for controlling the instruments 6, 8 to carry out the power spectrum measurement will be described in more detail shortly.

With reference to FIG. 2, each of the devices 4, 6, 8 generally includes a central processing unit (CPU) 22 that is coupled to a random access memory (RAM) 24, a read only memory (ROM) 26, a non-volatile storage unit 28 and other peripheral devices 30 via an internal bus 32. The bus 32 carries data signals, control signals and power to the various components of each device 4, 6, 8. The non-volatile storage unit 28 may be a floppy disk, a compact disc (CD), a chip card, a hard disk or the like. The other peripheral devices 30 may include a display, a keyboard, a mouse, and other device-specific components (all not shown). The display may be a video display, LCD display, touch-sensitive display, or other display types. The ROM 26 or the non-volatile storage unit 28 may serve as a program storage device for storing a program of instructions that is executable by the CPU 22 for implementing the respective portion of the sequence 40. The program may be implemented in any high level or low level programming languages.

The sequence 40 of operations in the controller 4 and the instruments 6, 8 for the controller 4 to control the instruments 6, 8 will be described next with the aid of FIG. 3. The sequence 40 starts in a SEND MESSAGE step 42 in the controller 4, wherein the controller 4 builds command messages and sends the command messages to the signal generator 6 and the spectrum analyzer 8. Each command message may include an operation type and a set of constraints. The command message for the spectrum analyzer 8 may be as follows:

(power.spectrum &&
p.error<0.001 W &&
t.latency<1e-3s &&
f.range includes [10 MHz, 100 MHz] &&
f.resolution<1 kHz)

In the above command message, “power.spectrum” is the operation type, more specifically measurement type, and the constraints include a power error of less than 0.001 W, a latency time of less than 1 msec, a frequency range of between 10 and 100 MHz, and a frequency resolution of less than 1 kHz. The command message for the signal generator 6 may or may not include an operation type. If the signal generator is operable to only generate a signal, there is no need for the operation type in the command message. However, if the signal generator 6 is operable to perform two or more operations, then the operation type is necessary to indicate which operation the signal generator is to perform. Each message may optionally include a constraint specifying triggering based on a trigger signal, such as triggering on a rising or a falling edge of the trigger signal.

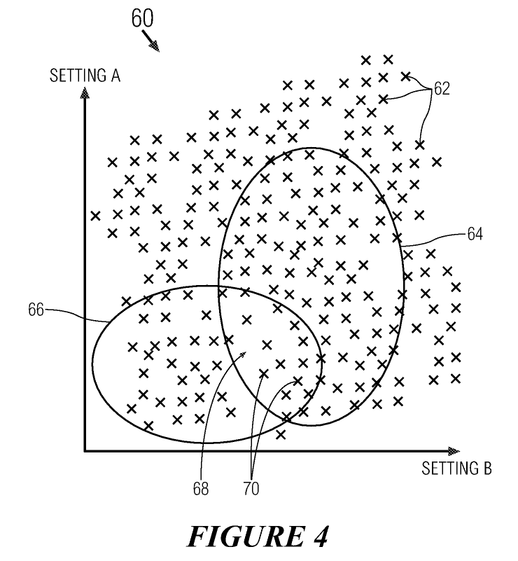

Each instrument 6, 8 has a state space 60 (FIG. 4) which includes the set of all states 62 that the instrument 6, 8 may be in. Any hardware or software parameter of the instrument 6, 8 that can be set or varied under control of the CPU 22 of the instrument 6, 8 is considered to be a component of a state 62. FIG. 4 is a drawing illustrating the state space 60 of the spectrum analyzer 8 with two settings of the spectrum analyzer 8. For the spectrum analyzer 8, the first constraint of power error of less than 0.001 W may be satisfied by a first set 64 of states 44 in the state space 60 of the spectrum analyzer 8. A state belongs to this first set 64 of states if the corresponding settings result in a measurement with a power error of less than 0.001 W. The second constraint of a latency time of less than 1 msec may be satisfied by a second set 66 of states in the state space 60 of the spectrum analyzer 8. A state belongs to this second set 66 of states if the corresponding settings result in a latency time of less than 1 msec. The intersection 68 of the two sets 64, 66 of states would satisfy both the first and second constraints. Each of the states in the intersection of the two sets of states is referred to as a “solution” 70 to the two constraints. Similarly, a state that satisfies the set of constraints in the command message is a solution 70 to that set of constraints.

The sequence 40 next proceeds to a RECEIVE MESSAGE step 44 in the instruments 6, 8, wherein each instrument 6, 8 retrieves the constraints from the command message sent thereto by the controller 4. The sequence 40 next proceeds to a DETERMINE IF CONSTRAINTS CAN BE MET step 46, wherein the instrument 6, 8 searches states 44 therein for a state 70 that is a solution to the set of constraints in the received command message. Each of the states 44 in the instrument 6, 8 defines constraints that can be met in that state 44. This searching in the state space 60 for a state or solution 70 corresponds to the solving of a constraint satisfaction problem (CSP) which is well known to those skilled in the art and is only briefly described here. For example, the instrument 6, 8 may solve the CSP obtained by comparing the constraints that are met by each of the states 44 in the instrument and the constraints received from the controller 4. In many instruments there are only a finite number of states 44. In these instruments the CSP can thus be solved by going over the states 44 in turn, checking each state 44 to see whether that state 44 satisfies the conjunction of all the constraints. When a state 44 does so, that state 44 is a solution 70 to the CSP. In some embodiments, a library of computer code that solves CSPs is used. Two such libraries are 1) Gecode, downloadable at http://www.gecode.org/ and 2) ECLiPSe, downloadable at http://eclipse.crosscoreop.com/ and described in the book Constraint Logic Programming using Eclipse, by Krzysztof R. Apt and Mark Wallace, Cambridge University Press, 2006. In some other embodiments, the entire CSP may be first reduced to an integer programming problem and then solved with a suitable integer programming code. Regardless of which method is used to solve a CSP, the solved CSP, more specifically the state or solution 70 that is found for the CSP, along with the constraints which is received and satisfied by the solution 70 are cached (or “memorized” in artificial intelligence terminology) in the instrument 6, 8 so that the same problem need not be re-solved from scratch when the same set of constraints is next received from the controller. In other words, the solution 70 that is found to be able to meet the set of constraints is cached in a cache (not shown) of the instrument 6, 8. This caching of the found solution 70 is advantageous because in most test systems the same test operation is often repeated. Second and successive repeated operations of the test or measurement will proceed faster than the first when this caching or memorization is provided.

If it is determined in the DETERMINE IF CONSTRAINTS CAN BE MET step 46 that there exist a state 44 in the instrument 6, 8 that is a solution 70 satisfying all of the constraints from the controller 4, the instrument 6, 8 begins to switch itself to that state 70. The instrument 6, 8 determines on its own accord a manner to get into the state 70 and will then go into the state 70 in the manner that is determined. In other words, the controller 4 does nothing more than sending the command message to the instrument 6, 8; the controller 4 is not directly involved, which is the case in the prior art, in getting the instrument 6, 8 to go into the state 70. The instrument 6, 8 having knowledge of its current state 44 and the desired state 70 to transition to can therefore optimize its transition to the desired state 70. For example, the instrument 6, 8 may be able to carry out more than one state transition in parallel to get to the desired state 70. If however, it is determined in this step 46 that there is no one state 44 in the instrument 6, 8 that will satisfy all of the constraints, i.e. no solution 70 is found, the instrument 6, 8 will not do anything but remain in its current state 44.

The sequence 40 next proceeds to a SEND RESPONSE step 48 in the instruments 6, 8, wherein each of the instruments 6, 8 sends a respective response message to the controller 4, in response to the command message, informing the controller 4 whether the instrument 6, 8 is able to meet the constraints and thus able to perform the operation. In the case where the instrument 6, 8 is able to meet the constraints, the response message may further include a readiness time at which the instrument 6, 8 will be ready to accept a trigger or command to begin performing the operation. The trigger may be a time trigger or a trigger signal. Assuming that the other instrument 6, 8 is also able to satisfy a respective set of constraints, the other instrument 6, 8 would also send a response message to the controller 4. This response message would similarly include a respective readiness time at which the second instrument 6, 8 will be ready to accept a trigger or command to begin performing a respective operation.

The sequence 40 next proceeds to a PROCESS RESPONSE step 50 in the controller 4. If a response message indicates that the instrument is unable to meet the constraints, the controller 4 will typically halt and inform a human operator of the failure. Typically, this condition indicates an out-of-calibration instrument. If however the response message indicates that the instrument 6, 8 is able to meet the constraints, the controller 4 would determine the later of the two readiness times received in the two response messages. This later time will be the common initiation time of the respective operations in the two instruments 6, 8. The sequence 40 next proceeds to a SEND INITIATION TIME step 52, wherein the controller 4 sends the initiation time to the instruments 6, 8 via either a broadcast message or individual messages to the instruments 6, 8. In the case of a single instrument 6, 8, the initiation time will be the readiness time of the instrument; there may not be the need to include the readiness time in the response message. In fact, the response message may not be needed at all in such a case. If there are more than two instruments, the initiation time will be the latest of all the readiness times of the instruments.

The sequence 40 next proceeds to a SET INITIATION TIME step 54 in the instruments 6, 8, wherein each of the instruments 6, 8 will enter the initiation time in an execute time register (not shown) in the instrument 6, 8. A time comparator (not shown) compares the time from the real time clock and the time in the execute time register. When the times match, the sequence 40 proceeds to the PERFORM OPERATION step 56, wherein the time comparator triggers an instrument front-end (not shown) to perform the operation. As mentioned above, the controller 4 may instead send a command to each of the instruments 6, 8 at the initiation time to cause the instruments 6, 8 to perform their respective operations.

Accordingly, from the description above, each instrument 6, 8 includes means 44 that receives at least one constraint for carrying out an operation, means 46 that determines if the constraint can be met and means 46 that determines on its own accord a manner to get into a state wherein the constraint will be met. The means 46 that determines if the constraint can be met may include a means 46 that searches the state space 60 for a state 44 wherein the constraint can be met. The instrument 6, 8 may further include a means that cache a state 70 that is found to be able to meet the constraint in a cache. In such a case, the means that searches the state space 60 includes a means that searches the cache first. The means 44 that receives at least one constraint may include a means that receives a message including the at least one constraint from a controller 4 communicatively connected to the instrument 6, 8. In such an embodiment, the instrument 6, 8 may further include means that sends a response to the controller 4 indicating whether the constraint can be met, wherein the response includes a readiness time at which the instrument 6, 8 is ready to perform the operation. The instrument 6, 8 further includes means that receives an initiation time from the controller 4, the initiation time being the latest of the readiness times received by the controller 4 from the instruments 6, 8 associated with the performance of the operations. The instruments 6, 8 may further include a means that waits at the initiation time for a command from the controller 4 or a means that triggers at the received initiation time to carry out the respective operation. The means may be implemented in software, firmware, hardware or any combination thereof.

Although the present invention is described as implemented in the above described embodiment, it is not to be construed to be limited as such. For example, it is described that the controller 4 and the instruments 6, 8 are LXI compliant devices connected via an Ethernet 10. This is not necessarily so; the invention may be implemented with devices that can communicate with each other over any network including, but not limited to, a Controller Area Network (CAN). Furthermore, protocols used by these devices for time synchronization may also include, among others, the Network Time Protocol (NTP), GPS or the like.

As another example, it should not be construed that each instrument 6, 8 has to have a specific operation to perform. It is possible that a device does not have an operation to perform but requires the initiation time to be a time when a specific condition is reached or deemed to have been reached. An example of such a condition includes the ambient temperature being at some value.

As yet another example, the method of controlling a device should not be construed to be applicable to only the two specific instruments 6, 8 described above; the method is also applicable to other instruments that are common in a testing environment such as power supplies, oscilloscopes, network analyzers, signal generators, signal analyzers, switch matrices, etc. It should also be noted that the instruments may be connected to other types of wired or wireless networks. The method may also be implemented in systems that are non-testing related, such as but not limited to, networked control systems, industrial automation systems, computer networks, and telecommunication systems. Consequently, the devices may include robots, controllers, servers, routers, switches, workstations, personal digital assistants, mobile phones, and the like. Accordingly, the operation may thus be a test operation, a measurement operation or a control operation. The method may also be implemented in a single piece of equipment. In such a case, the devices may be separate cards that are connected to a common bus in the equipment, or the devices may be separate hardware or software modules. The constraints depend on the type of device and the operation to be performed by the device. For example, a spectrum measurement will require constraints on frequency range and resolution whereas capturing a voltage waveform will require instead constraints on sampling rate, voltage range, and amount of time to capture. The constraints may thus include, in addition to those described above and among others, the minimum time to perform a measurement, a signal generation, or a control operation, the maximum allowed error or noise permitted, the range of the relevant physical variables (voltages, currents, frequencies, etc.) to be supported. Yet other sorts of constraints may specify triggering based on a trigger signal, such as triggering on a rising or a falling edge of a trigger signal.

As yet a further example, the method is not required to be implemented on a controller 4 and two instruments 6, 8 as described above. The method may be implemented in a system with one controller and a single device. The instrument may simply return a response message including whether it is able to meet the constraints with or without providing any readiness time. In fact, the method may be implemented in a single device without the need for any controller. The constraints may be entered into the device via a suitable user interface or an input device, such as a keyboard, that is a part of the device or connected thereto by a any suitable data transmission means including but not limited to a parallel or serial, Firewire, USB, PCI, PCI-express connection, etc. Furthermore, there may not be a need for the operation type to be provided to the device; the constraints alone would suffice for the device to determine whether they can be met when the device can perform only a single operation.

As yet another example, the method may be implemented in a computing device that includes the state spaces of a number of devices. When the computing device receives a set of constraints, the computing device can return a list of devices that are able to meet those constraints. In the event that no device is able to meet the constraints, the computing device may provide a list of devices that are able to meet constraints that are close to those provided and a list of these constraints.

What is claimed is:

1. A method of controlling at least one device, the method comprising:
providing the device with at least one constraint for carrying out an operation;
the device determining if the constraint can be met; and
if it is determined that the constraint can be met, the device determining on its own accord a manner to get into a state wherein the constraint will be met, and the device going into the state in the determined manner.

2. A method according to claim 1, wherein the device includes a plurality of states stored therein, each state defining constraints that can be met in the state, and wherein the device determining if the constraint can be met comprises searching the plurality of states for a state wherein the constraint can be met.

3. A method according to claim 2, further comprising caching a state that is found to be able to meet the constraint in a cache, and wherein searching the plurality of states comprises searching the cache first.

4. A method according to claim 1, further comprising providing the device with an operation type corresponding to the operation.

5. A method according to claim 1, wherein providing the device with at least one constraint comprises a controller communicatively connected to the device sending the device a message including the constraint.

6. A method according to claim 5, further comprising the device sending a response to the controller indicating whether the constraint can be met.

7. A method according to claim 6, wherein the device sending a response to the controller comprises the device sending the controller a response that further includes a readiness time at which the device is ready to perform the operation.

8. A method according to claim 7, further comprising:
the controller determining an initiation time from the at least one readiness time received from the at least one device, the initiation time being the latest of the at least one readiness time; and
the controller sending the initiation time to the device.

9. A method according to claim 8, further comprising the device waiting at the received initiation time for a command from the controller.

10. A method according to claim 8, wherein the message further comprises a trigger and the method further comprising the device triggering at the received initiation time to carry out the operation in the state.

11. A device comprising:
means that receives at least one constraint for carrying out an operation;
means that determines if the constraint can be met;
means that determines on its own accord a manner to get into a state wherein the constraint will be met.

12. A device according to claim 11, wherein device includes a plurality of states stored therein, each state defining constraints that can be met in the state, and wherein the means that determines if the constraint can be met comprises a means that searches the plurality of states for a state wherein the constraint can be met.

13. A device according to claim 12, further comprising a means that cache a state that is found to be able to meet the constraint in a cache, and wherein the means that searches the plurality of states comprises a means that searches the cache first.

14. A device according to claim 11, wherein the means that receives at least one constraint comprises a means that receives a message including the at least one constraint from a controller communicatively connected to the device.

15. A device according to claim 14, further comprising:
means that sends a response to the controller indicating whether the constraint can be met; the response including a readiness time at which the device is ready to perform the operation;
means that receives an initiation time from the controller, the initiation time being the latest of at least one readiness time that is received by the controller from a respective device associated with the performance of the operation; and
at least one of a means that waits at the initiation time for a command from the controller and a means that triggers at the received initiation time to carry out the operation in the state.

16. A system comprising:
a controller; and
at least one device communicatively connected to the controller, the device comprising:
means that receives at least one constraint for carrying out an operation from the controller;
means that determines if the constraint can be met;
means that determines on its own accord a manner to get into a state wherein the constraint will be met.

17. A system according to claim 16, wherein the device includes a plurality of states stored therein, each state defining constraints that can be met in the state, and wherein the means that determines if the constraint can be met comprises a means that searches the plurality of states for a state wherein the constraint can be met.

18. A system according to claim 17, wherein the device further comprises a means that cache a state that is found to be able to meet the constraint in a cache, and wherein the means that searches the plurality of states comprises a means that searches the cache first.

19. A system according to claim 16, wherein the device further comprises:
means that sends a response to the controller indicating whether the constraint can be met; the response including a readiness time at which the device is ready to perform the operation;
means that receives an initiation time from the controller, the initiation time being the latest of at least one readiness time that is received by the controller from the at least one device associated with the performance of the operation; and
at least one of a means that waits at the initiation time for a command from the controller and a means that triggers at the received initiation time to carry out the operation in the state.
